(19) United States
(12) Patent Application Publication
(10) Pub. No.: US 2006/0093478 A1
(43) Pub. Date: May 4, 2006

(54) Guide device of an axial flow fan

(75) Inventors: Wen-Hao Liu, Taipei (TW); Shou-Te Yu, Taipei (TW)

Correspondence Address: G. LINK CO., LTD.;PmB 174, 931 West 75th Street, Suite 137, Naperville, IL, 60565, US

(73) Assignee: ASIA VITAL COMPONENT CO., LTD.

(21) Appl. No.: 10/979,203

(22) Filed: Nov. 3, 2004

(51) Int. Cl. F03B 11/02

(52) U.S. Cl. 415/208.1

(57) ABSTRACT

An axial flow fan comprises a fan frame and a fan blade wheel. The fan flame has an inlet and an outlet with a support device at the outlet. The fan blade wheel is received in the fan frame. The support device at least has a guide flow device to guide flowing fluid during the fan blade wheel rotating. In this way, a stagnation area can be resisted at the fan and enhances effect of heat dissipation.

### BACKGROUND OF THE INVENTION

1. Field of the Invention

The present invention is related to a guide flow device of an axial flow fan and particularly to a fan frame with which flow direction of the fluid can be controlled.

2. Brief Description of the Related Art

Referring to FIGS. 1 to 3, the conventional axial flow fan 1 includes a fan frame 11 and a fan blade wheel 12. The fan frame 11 provides an inlet 111 and an outlet 112. A hub seat 113 is provided at the outlet 112 with a radial support device 114 at the periphery thereof. The support device 114 is connected to the hub seat 113 at an end thereof and is connected to the fan frame 11 at another end thereof. The fan blade wheel 12 is disposed in hub seat 113 of the fan frame 11.

Referring to FIG. 4, when the fan blade wheel 12 rotates to move the fluid inward via the inlet 111, the fluid then can blow outward via the outlet 112 along two lateral sides of the fan frame 11. As a result, a stagnation area 14 is created at the rear side of the hub seat 113 due to no fluid flowing through there.

Referring to FIGS. 5 and 6, the conventional axial flow fan 1 is associated with a radiator 15. The radiator 15 is closely attached to a heat generation element 16 and the axial flow fan 1 is joined to the radiator 15. When the fluid 13 moves inward via the inlet 111 and blows outward toward the radiator 15 at the outlet 112, heat source can be removed from two end sides 152, 153 of the radiator 15 via air clearances 151. Usually, the heat generation element 16 is placed at the center of the radiator 15 and when the heat generation element 16 produces heat, the radiator 15 is full with the heat due to conduction. Meanwhile, it results in heat at center of the radiator 15 is greater than rest part of the radiator 15. A problem of the conventional axial flow fan 1 is that a stagnation area 14 is created at the rear side of the hub seat 13 to resist heat at the central part of the radiator 15 being brought out so as to affect effect of heat dissipation significantly.

### SUMMARY OF THE INVENTION

An object of the present invention is to provide a guide flow device in an axial flow fan with which flow direction of the fluid can be controlled to overcome efficiency of the stagnation area and enhance heat dissipation effectively.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of the conventional axial flow fan;

FIG. 2 is another exploded perspective view of the conventional axial flow fan;

FIG. 3 is an assembled view of the conventional axial flow fan;

FIG. 4 is a sectional view of the conventional axial flow fan illustrating the air being moved during the fan being in operation;

FIG. 5 is a sectional view of the conventional axial flow fan associated with a radiator;

FIG. 6 is a sectional view of the conventional axial flow fan associated with a radiator illustrating the air being moved during the fan being in operation;

FIG. 7 is an exploded perspective view of a preferred embodiment of an axial flow fan according to the present invention;

FIG. 8 is another exploded perspective view of the preferred embodiment of an axial flow fan according to the present invention;

FIG. 9 is an assembled perspective view of the preferred embodiment of an axial flow fan according to the present invention;

FIG. 10 is a sectional view of the preferred embodiment of an axial flow fan according to the present invention illustrating the air being moved during the fan being in operation;

FIG. 11 is an exploded perspective view of the preferred embodiment of an axial flow fan according to the present invention being associated with a radiator;

FIG. 12 is an assembled perspective view of the preferred embodiment of an axial flow fan according to the present invention being associated with a radiator;

FIG. 13 is a top view illustrating the preferred embodiment of an axial flow fan according to the present invention being associated with a radiator;

FIG. 14 is a sectional view illustrating the preferred embodiment of an axial flow fan according to the present invention being associated with a radiator; and

FIG. 15 is a sectional view illustrating another type of guide flow device of an axial flow fan according to the present invention.

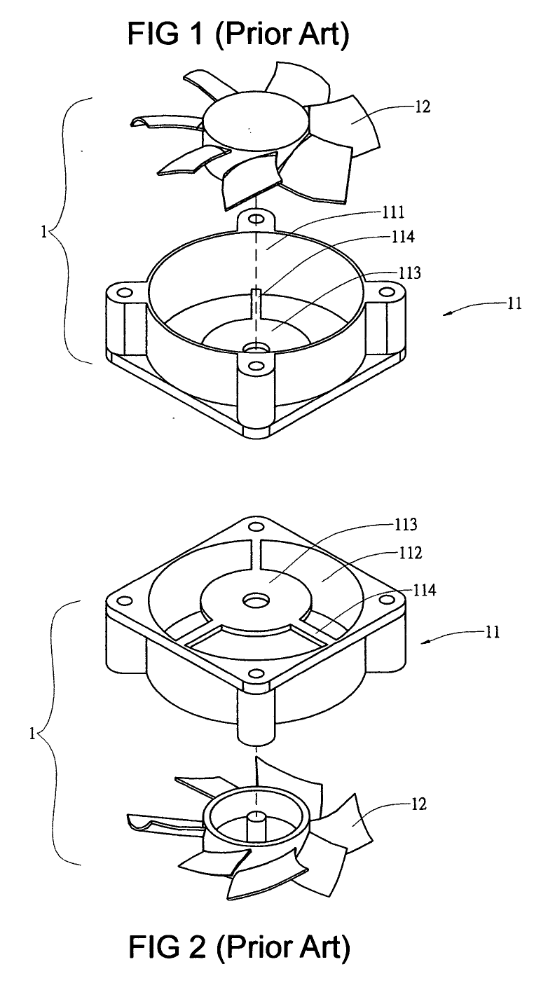

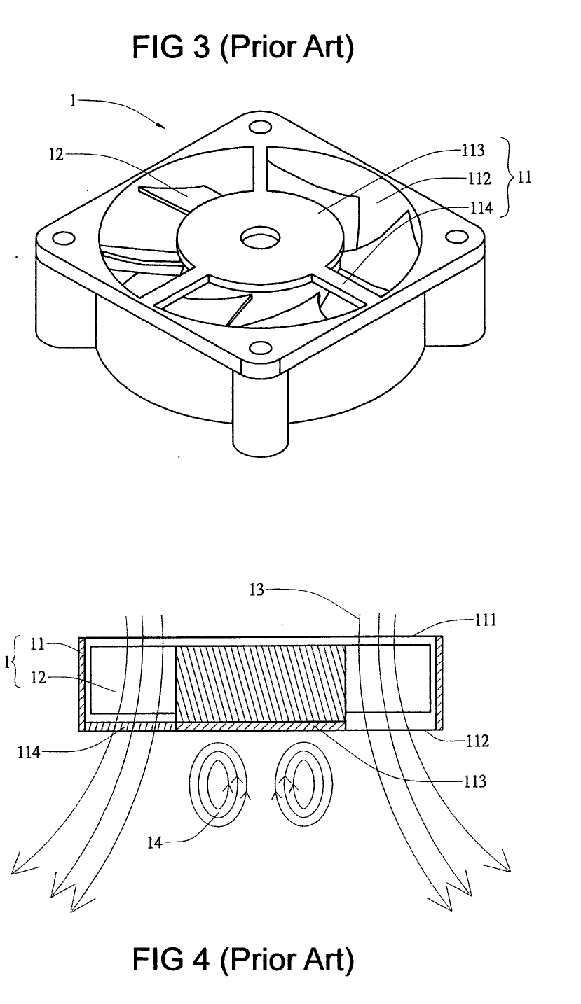

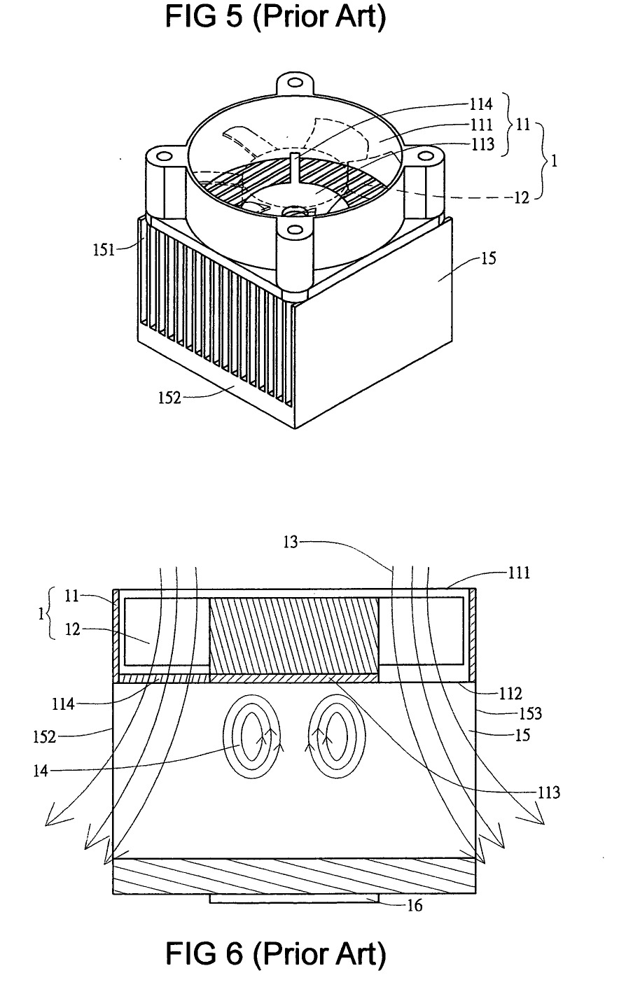

### DETAILED DESCRIPTION OF THE INVENTION

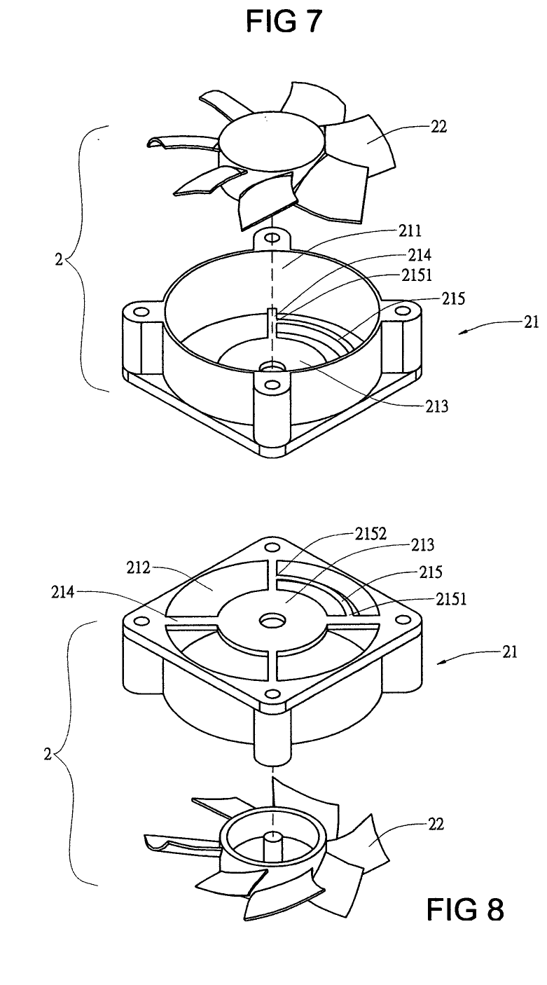

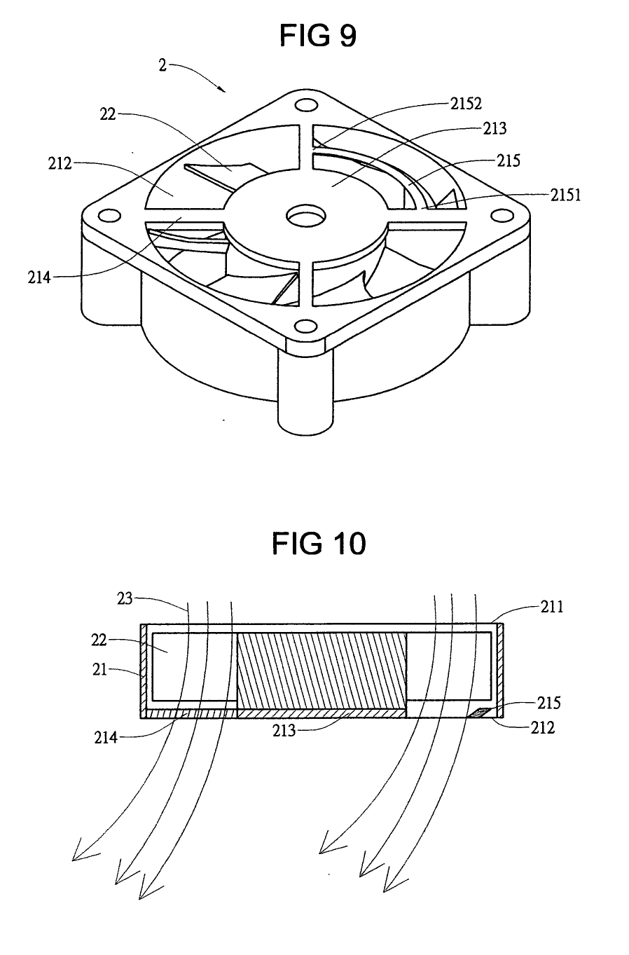

Referring to FIGS. 7, 8 and 9, the preferred embodiment of an axial flow fan according to the present invention comprises a fan frame 21 and a fan blade wheel 22. The fan frame 21 provides an inlet 211 and an outlet 212. A hub seat 213 with at least a guide flow device tilting downward to the fan frame 21 is located at the outlet 215. At least a support device 214 radially extends along the periphery of the hub seat 213 with an end thereof connecting with the frame 21. The guide flow device 215 has a circular shape with an initial end 2151 and a terminal end 2152 disconnecting from each other. The initial end 2151 and the terminal end 2152 are connected to the support device 214 respectively to allow the guide flow device 215 being provided at the outlet 212. The fan blade wheel 22 is attached to the hub seat 213 in the fan frame 21.

Referring to FIG. 10, once the fan blade wheel 22 rotates, fluid is moved inward via the inlet 211 and flows toward the outlet 212. While the fluid moves toward the outlet 212 and guided with the guide flow device 215 to flow leftward, a flow area at the back of the hub seat 213 is restrained from occurring a phenomenon so as to enhance effect of heat dissipation.

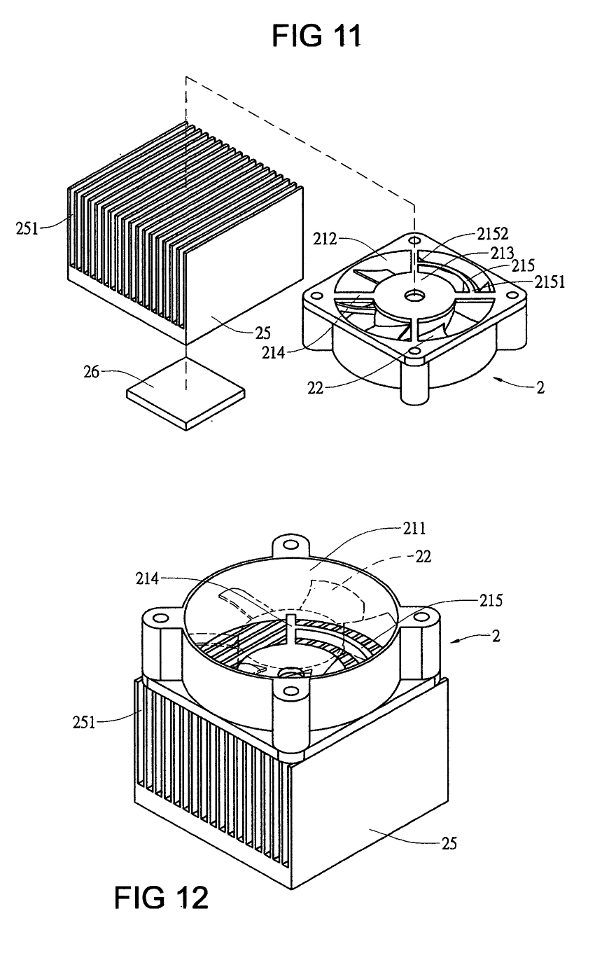

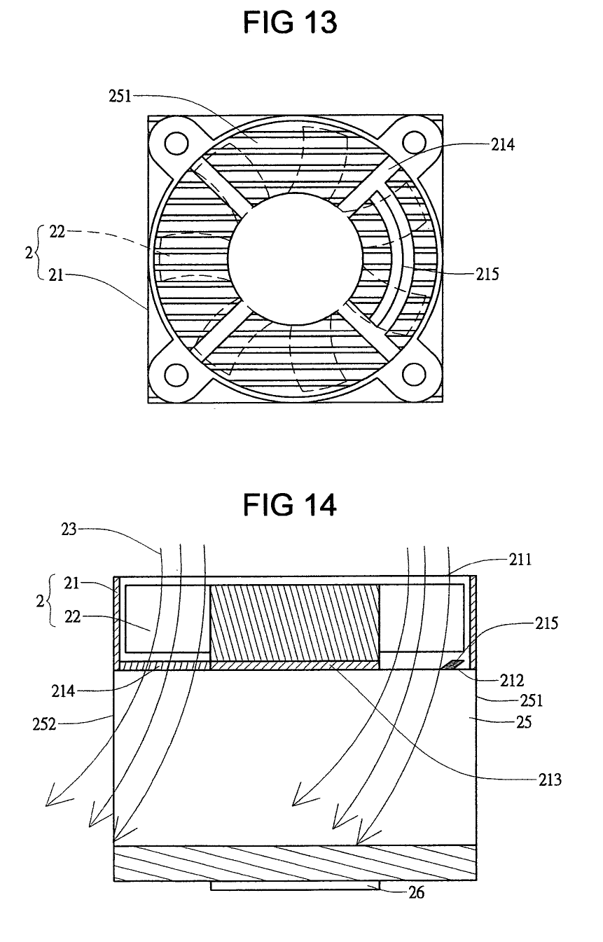

Referring to FIGS. 11 to 14, a radiator 25 is associated with the axial flow fan of the present invention. It can be seen that the radiator 25 is closely touched to a heat generating component 26 and the radiator 25 is mounted to the axial flow fan 2 in a way of the guide flow device 215 being disposed across air clearances 251 of the radiator 25. Hence, the fluid 23 moves inward via the inlet 211 of the fan frame 21 and blows toward the radiator 25 at the outlet 212 such that the fluid 23 is guided with the guide flow device 215 to flow toward the center of the radiator 25 and then move out via the left side of the radiator 25. In this way, heat in the center of the radiator 25 can be brought out to enhance effect of the heat dissipation.

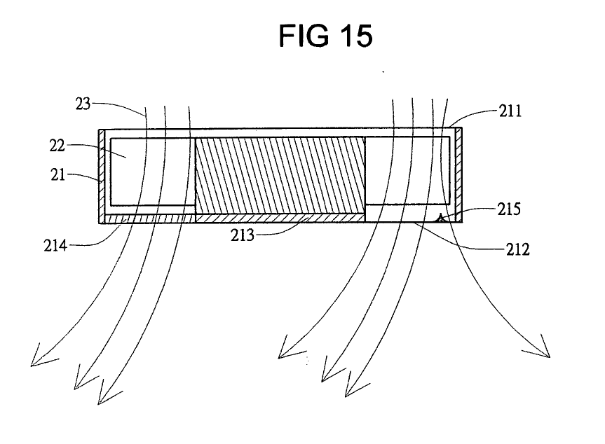

Referring to FIG. 15, it can be seen from the sectional view that the guide flow device 215 can be tilted at both sides thereof instead and the fluid 23 blowing outward from the outlet 212 is guided to form divided flows. Most of the fluid 23 flows leftward and rest of it flows rightward to prevent from producing the stagnation area and to allow heat at the right side moving out. Hence, the guide flow device 215 can increase heat dissipation area and broaden application field of the present invention.

While the invention has been described with referencing to preferred embodiments thereof, it is to be understood that modifications or variations may be easily made without departing from the spirit of this invention, which is defined by the appended claims.

What is claimed is:

1. An axial flow fan, comprising
a fan frame, providing an inlet and an outlet and a support device at the outlet; and
a fan blade wheel, being received in the fan frame;
characterized in that the support device at least has a guide flow device to guide flowing fluid during the fan blade wheel rotating to resist creating a stagnation area;
whereby, provision of the guide flow device enhances effect of heat dissipation.

2. The axial flow fan as defined in claim 1, wherein the guide flow device has an initial end and a terminated end being apart from each other.

3. The axial flow fan as defined in claim 1, wherein the guide flow device tilts downward from top thereof.

4. The axial flow fan as defined in claim 1, wherein the guide flow device is tilted at two sides thereof.
